(19) United States
(12) Patent Application Publication
(10) Pub. No.: US 2009/0169349 A1
(43) Pub. Date: Jul. 2, 2009

(54) Conveyor with set-back front wheel assembly

(76) Inventor: Wesley C. Reed, Jonesboro, AR (US)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 12/006,365

(22) Filed: Jan. 2, 2008

(51) Int. Cl. B65G 67/08

(52) U.S. Cl. 414/507; 414/809

(57) ABSTRACT

A conveyor for loading items into a trailer, the conveyor comprising a transport surface with a discharge end and a receiving end, a belt or rollers on a top side of the transport surface that transports items over the transport surface, and a wheel assembly coupled to a bottom side of the transport surface at a distance of approximately L from the discharge end of the conveyor, where the distance L is approximately 75-88% of the length of the trailer. Embodiments of the invention may be used to safely transport items to and from a drop-frame trailer with a trailer conveyor assembly that is mounted on the bottom interior surface of the drop-frame trailer. Some embodiments of the invention may further comprise an obstruction sensor mounted on at least one of the bottom side of the transport surface between the wheel assembly and the discharge end of the transport surface, or on the discharge end of the transport surface.

### FIELD OF THE INVENTION

Embodiments of the invention relate to conveyors that are used to load items into a trailer. In particular, conveyors according to some embodiments of the invention can be safely used with trailers having built-in trailer conveyor assemblies.

### BACKGROUND

Items that are housed within a location such as a warehouse, distribution center, or manufacturing facility are oftentimes heavy and/or cumbersome, and cannot be transported by human strength alone. Accordingly, machines such as fork lifts or conveyor systems are used to assist in transporting items within a location, or between locations. For example, a fork lift or a conveyor may be used to transport items between a warehouse and a trailer, or between a manufacturing facility and a truck. These machines are beneficial in that they prevent overexertion, strain, or injury caused by attempting to transport items by human strength alone. Items can include boxes, crates, cartons, or pallets loaded with goods, containers, boxes, and the like.

Conveyors and trailers that are typically used to transport items between locations are known. These include telescoping conveyors, boom conveyors, sidebar or tong conveyors, flexible conveyors, or expandable conveyors. There are different types of trailers, such as dock height trailers, drop frame trailers, moving vans, eighteen wheeler trucks, flat bed trailers, and the like. Some trailers, such as drop frame trailers, have conveyor systems built into the trailer. A drop-frame trailer refers to a trailer with a bottom interior surface that is lower than the standard height of a dock. For example, docks are typically 48 inches high, and the bottom interior surface of the dock height trailer is typically 18-24 inches below the dock. The bottom interior surface of the trailer is commonly referred to as the “belly” of the trailer. The belly may be equipped with a built-in conveyor system, for example, a built-in conveyor system may have a frame and gravity rollers. The frame may be mounted on the bottom interior surface of the trailer, and may be elevated a certain height above the bottom surface. In some trailers the frame and the gravity rollers may be as much as twenty four (24) inches above the bottom surface of the belly.

Typical use of a drop-frame trailer with a built-in conveyor system may proceed as follows. The trailer may be positioned adjacent to a loading dock of a warehouse. A dock conveyor may be mounted to or sitting on the loading dock. Typically, the dock conveyor has a belt, wheels, or rollers on its surface to easily transport items.

In a first scenario, the dock conveyor remains positioned outside of the trailer without entering the trailer. In this scenario, a first worker typically stands on the bottom interior surface of the trailer where there is not a built-in conveyor system. The worker may receive items that are transported on the dock conveyor towards the truck. When an item approaches the discharge end of the dock conveyor, the worker may pick it up and then place it on the belly conveyor system that is built into the trailer. There may be a second worker that is standing within the belly of the trailer, who may receive the items from the first worker. The second worker may push the items over the belly conveyor system to a desired location within the trailer. This scenario is disadvantageous, however, because both the first and second workers are prone to injuries due to stress, strain, and over exertion in handling and picking up the items. For example the first worker may become injured when picking items up from the dock conveyor and placing them on the belly's conveyor system.

In a second scenario, the dock conveyor extends into the trailer. The dock conveyor is often not high enough to clear the belly conveyor system that is built into the trailer, however. As a result, the dock conveyor can collide with the belly conveyor, and cause damage to either the dock conveyor, the belly conveyor, or both. If the belly conveyor becomes damaged, then items may be prohibited from being transported over the belly conveyor. Therefore, a worker would be required to manually transport items within the trailer without the help of the belly conveyor. On the other hand, if the dock conveyor becomes damaged then the dock as a whole might have to shut down. For example, typically there are “dedicated” dock conveyors that are fixed to the dock. If a dock conveyor is damaged it cannot be easily substituted with a working dock conveyor. Instead, the damaged dock conveyor must be repaired, which takes time and prohibits use of the dock.

If either the belly conveyor or the dock conveyor is damaged, it increases cost. For example, the owners of the trailer and the dock conveyor incur repair costs, and their insurance premiums may be increased. Costs are also sacrificed due to inefficiencies caused by the damage. If a dock conveyor is shut down then items cannot be transported on schedule, and if the belly conveyor is broken then it might take longer amounts of time to appropriately load the trailer for transport.

Accordingly, there is a need for a dock conveyor that can be used to efficiently and safely load items into a trailer, and in particular a trailer with a built-in conveyor system, that will not damage the dock conveyor or the trailer conveyor.

### SUMMARY

In some embodiments, there is provided a method of loading items into a trailer, the method comprising providing a location to position a trailer with a length L₁, the trailer comprising: a trailer conveyor assembly connected to a bottom interior surface of the trailer, the trailer conveyor assembly comprising a trailer conveyor frame and a trailer transport surface; providing a conveyor assembly, the conveyor assembly comprising: a frame with a top surface, a bottom surface, and a discharge end; a transport surface rotatably connected to the top surface of the frame; a discharge-end wheel assembly coupled to the bottom surface of the frame at a distance of approximately L₂ from the discharge end of the frame, where the distance L₂ is approximately 75-88% of L₁; an obstruction sensor connected to the bottom surface of the frame between the discharge-end wheel assembly and the discharge end of the frame to preclude the conveyor from extending into the conveyor past the length L₂; extending the conveyor assembly into the trailer, wherein when the conveyor assembly is extended into the trailer, the bottom surface of the frame is substantially parallel to the trailer transport surface; generating a signal when the obstruction sensor encounters the trailer conveyor frame or the trailer transport surface of the trailer conveyor assembly; receiving the signal and stopping the extension of the conveyor assembly into the trailer beyond the length L₂; transporting items on the transport surface towards the discharge end of the frame; and causing items to be deposited into the trailer.

According to some embodiments, the method further comprises causing items to be received on the trailer transport surface and transporting items on the trailer transport surface into the trailer.

According to some embodiments, the method includes providing a conveyor assembly that has a distance L₂ that is approximately 75-82% of L₁.

According to some embodiments, the conveyor assembly further comprises a bumper bar on the discharge end of the frame, and the method further comprises generating a bumper signal when the bumper bar encounters an object; and receiving the bumper signal and completing a reaction, wherein the reaction comprises at least one of stopping the extension of the conveyor assembly into the trailer, or causing the conveyor to back up away from the trailer.

According to some embodiments, there is a method wherein the trailer transport surface or the transport surface comprises at least one of rollers, a belt, skate wheels, or a smooth plane.

According to some embodiments, the method further comprises providing an operational system to receive the signal and to thereafter initiate a command to stop the extension of the conveyor assembly into the trailer.

In some embodiments, there is provided a system for transporting items to and from a loading dock with a height D, the system comprising: a conveyor having an overall length L_{C} and comprising: a frame with a top surface, a bottom surface, and a discharge end; a conveyor transport surface rotatably mounted to the top surface of the frame; and a discharge-end wheel assembly coupled to the bottom surface of the frame, and set back from the discharge end of the frame at a distance of approximately 40-45% of L_{C}; a trailer, comprising a bottom interior surface with a first portion and a second portion, the second portion comprising a trailer transport surface that is elevated from the first portion by a height H₂; wherein when the conveyor is inserted into the trailer, the bottom surface of the frame is substantially parallel to the trailer transport surface and is offset from the trailer transport surface by a clearance C; and there is adequate space between the discharge end of the frame and a far wall of the trailer for a worker to stand and load items.

According to some embodiments, the conveyor transport surface or the trailer transport surface comprises at least one of rollers, a belt, skate wheels, or a smooth plane.

According to some embodiments, the conveyor further comprises a bumper bar mounted on the discharge end of the frame, wherein when the bumper bar encounters an object, the bumper bar generates a signal to cause at least one of stopping the insertion of the conveyor or backing the conveyor away from the trailer.

According to some embodiments, the bottom surface of the frame is located at a height H₁ above the dock, wherein the height H₁ approximately equals: the sum of the height H₂, a distance B from the ground to the bottom surface of the trailer, and the clearance C; minus the height of the dock D.

According to some embodiments, the discharge end wheel assembly comprising a guide roller.

According to some embodiments, the system further comprises a guide rail assembly, the guide rail assembly comprising: a channel defined by a straight portion of two rails; and a funnel defined by a curved portion of the two rails, wherein the guide-roller of the discharge-end assembly translates in the channel and the funnel of the guide rail assembly.

According to some embodiments, the conveyor further comprises an obstruction sensor mounted on the bottom surface of the frame in front of the discharge-end wheel assembly, wherein the obstruction sensor generates a signal to stop insertion of the conveyor when the obstruction sensor encounters an edge of the trailer transport surface.

In some embodiments, there is provided a system for transporting items to and from a loading dock, the system comprising: a drop-frame trailer with a length L and a bottom interior surface, the trailer comprising a trailer transport surface mounted to at least a portion of the bottom interior surface of the trailer; a conveyor comprising: a frame with a top side, a bottom side, a receiving end, and a discharge end; a conveyor transport surface rotatably coupled to the top side of the frame; a wheel assembly comprising a first guide roller coupled to the bottom side of the frame at a distance of approximately five to seven feet less than L from the discharge end of the frame; and an obstruction sensor mounted on the bottom side of the frame at a location between the wheel assembly and the discharge end of the frame; and wherein when the conveyor enters the drop-frame trailer, the bottom side of the frame translates substantially parallel to the trailer transport surface.

According to some embodiments, the obstruction sensor generates a signal to stop the conveyor when the obstruction sensor encounters an edge of the trailer transport surface.

According to some embodiments, the system further comprises a support structure mounted to the bottom side of the frame between the wheel assembly and the receiving end of the frame, the support structure comprising a second guide roller.

According to some embodiments, the system further comprises a guide rail assembly, the guide rail assembly comprising a first guide rail with a straight portion and a flared portion; and a second guide rail with a straight portion and a flared portion, wherein the first and second guide rails are mounted on the ground; wherein when the conveyor extends into the drop frame trailer, the first and second guide rollers translate between the first and second guide rail.

According to some embodiments, the system further comprises two drop guards mounted adjacent to at least a portion of a left and right edge of the frame transport surface.

According to some embodiments, the conveyor transport surface or the trailer transport surface comprises at least one of rollers, a belt, skate wheels, or a smooth plane.

In some embodiments, there is provided a method of unloading items from a trailer, the method comprising: providing a location to position a trailer with a length L₁, the trailer comprising: a trailer conveyor assembly connected to a bottom interior surface of the trailer, the trailer conveyor assembly comprising a trailer conveyor frame and a trailer transport surface; providing a conveyor assembly, the conveyor assembly comprising: a frame with a top surface, a bottom surface, and a discharge end; a transport surface rotatably connected to the top surface of the frame; a discharge-end wheel assembly coupled to the bottom surface of the frame at a distance of approximately L₂ from the discharge end of the frame, where the distance L₂ is approximately 75-82% of L₁; an obstruction sensor connected to the bottom surface of the frame between the discharge-end wheel assembly and the discharge end of the frame to preclude the conveyor from extending into the conveyor past the length L₂; extending the conveyor assembly at least partially into the trailer, wherein when the conveyor assembly is extended into the trailer, the bottom surface of the frame is substantially parallel to the trailer transport surface; generating a signal when the obstruction sensor encounters the trailer conveyor frame or the trailer transport surface of the trailer conveyor assembly; receiving the signal and stopping the extension of the conveyor assembly into the trailer beyond the length L₂; transporting items on the transport surface towards the receiving end of the frame; and removing items from the conveyor assembly.

### BRIEF DESCRIPTION OF THE FIGURES

FIG. 1 is an isometric view of a conveyor according to some embodiments of the invention.

FIG. 2 is a top view of the conveyor shown in FIG. 1.

FIG. 3 is a side view of the conveyor shown in FIGS. 1 and 2.

FIG. 4 is a back-end view of the conveyors shown in FIGS. 1 through 3.

FIGS. 5A-5D are various views of a discharge-end wheel assembly of conveyors according to some embodiments of the invention.

FIGS. 6A-6D are various views of a receiving-end wheel assembly of conveyors according to some embodiments of the invention.

FIG. 7 is a top view of a guide rail assembly for use with conveyors according to some embodiments of the invention.

FIG. 8 is a side view of a trailer for use with some conveyors of the invention.

FIG. 9 is a sectional view of the trailer shown in FIG. 8.

FIG. 10 is a back-end view of the trailers shown in FIGS. 8 and 9.

FIG. 11 is a side view of the trailer shown in FIG. 8, with a conveyor extending into the conveyor according to some embodiments of the invention.

FIG. 12 is a detailed view of a portion of FIG. 11.

FIG. 13 shows methods according to some embodiments of the invention.

FIG. 14 is a schematic diagram showing an operational system belonging to some embodiments of the invention.

### DETAILED DESCRIPTION OF THE FIGURES

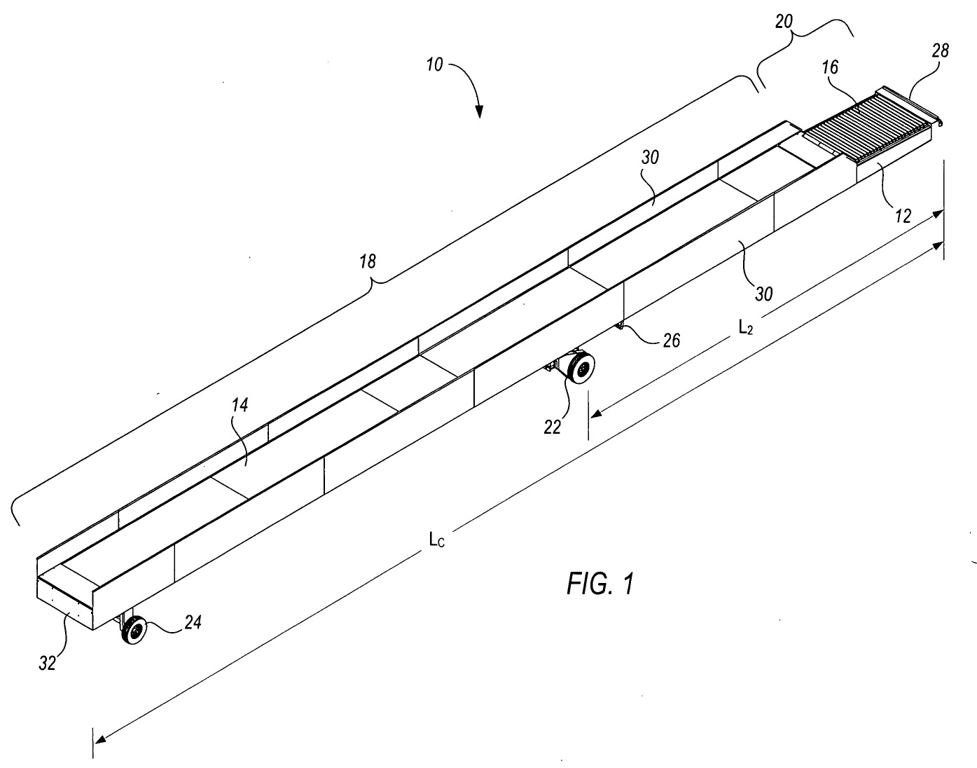

Conveyors 10 according to some embodiments of the invention are provided for loading items into a trailer 80, or removing items from a trailer 80. Some conveyors 10 have a frame 12. The frame 12 may be made of steel, aluminum, or an alloy. The frame 12 may be constructed from portions of metal, and the portions can be assembled together by welding, gluing, or using fasteners such as bolts, nuts, screws, and the like. The frame 12 may have a discharge end, a receiving end, a top surface, and a bottom surface. As shown in FIG. 1, the frame 12 is not a telescoping conveyor such as is described in U.S. Pat. No. 7,004,308 to Parks et al. A telescoping design increases the amount of hardware and the degrees of freedom of the conveyor. For example, telescoping conveyors are able to extend in any number of lengths, which increases the likelihood of a collision with the conveyor. Furthermore, a telescoping conveyor requires more framework than conveyors that do not telescope. As will be described in more detail below, providing a frame 12 that does not telescope is beneficial because it reduces the degrees of freedom and the amount of framework, thus reducing the possibility that the frame 12 might collide with a trailer 80, or with a trailer conveyor assembly 90 located inside the trailer 80.

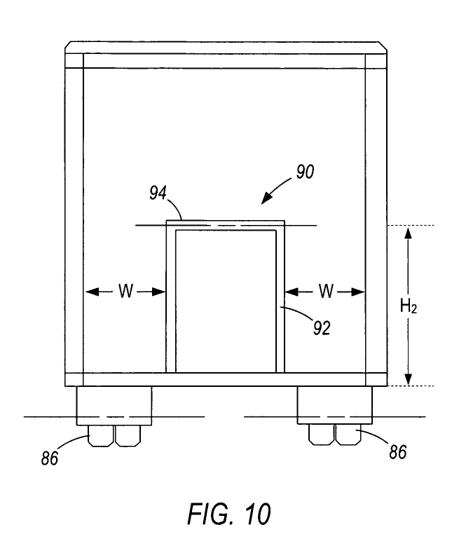

The width of the conveyor 10 may vary depending on the widths of trailers 80. For example, many trailers 80 have widths of eight to nine (8-9) feet. Conveyors 10 of some embodiments have a width of approximately 30-40 inches, to be inserted into the trailer 80 with adequate room for clearance between the conveyor 10 and the walls of the trailer 80, as shown in FIG. 10, for example. Other conveyors 10 may be wider, depending upon the intended use of the conveyor 10.

Some conveyors 10 of the invention are associated with a dock 110 that opens up into a warehouse, storage center, distribution center, or the like. The conveyor 10 can sit on the surface of the dock 110 so that it can freely translate over the surface, as described more fully below. Some docks 110 may be associated with a warehouse or distribution center that has a conveyor system within the warehouse that is used to transport items within the warehouse. For example, some warehouse conveyor systems (not shown) may have a conveyor that is generally positioned along the inside perimeter of the warehouse, with offshoot conveyors that divert items from the perimeter to a dock. The offshoot conveyor may be elevated so that there is a space between the dock and the offshoot conveyor. In some embodiments, the conveyor 10 is positioned underneath the offshoot conveyor associated with the warehouse. In such embodiments, the conveyor 10 can still translate freely over the surface of the dock, underneath the offshoot conveyor within the warehouse.

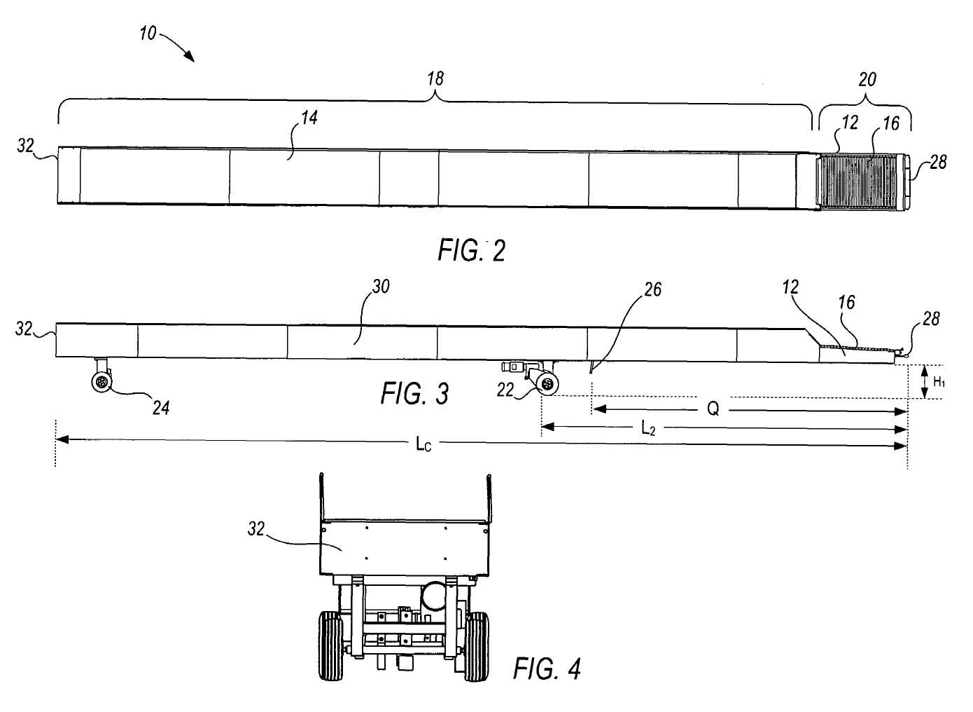

The conveyor 10 may have at least one transport surface 14 that is rotatably coupled to the top surface of the frame 12. The conveyor transport surface 14 can have a variety of embodiments. In the embodiments shown in FIGS. 1-3, the conveyor transport surface 14 is a belt. In some embodiments, there is a motor coupled to the belt 14 that causes the belt 14 to rotate. The motor may cause the belt 14 to rotate in a first direction so that items translate from the receiving end of the frame 12 to the discharge end of the frame 12. Additionally, the motor may cause the belt 14 to rotate in a second direction so that items translate in the opposite direction, from the discharge end of the frame 12 to the receiving end of the frame 12.

Some embodiments of conveyors 10 have a second transport surface 16. If the conveyor 10 has a first transport surface 14 that is driven, then the second transport surface 16 may be non-driven, in order to slow the items down as they approach the discharge end of the conveyor 10. In other embodiments, the second transport surface 16 is driven. The second conveyor transport surface 16 may be a set of rollers, a belt, skate wheels, or a smooth plane. As shown in FIGS. 1-3, the second transport surface 16 may be slanted down in the direction of the discharge end of the conveyor 10. In other embodiments, the second transport surface 16 is not slanted, but is parallel with the first transport surface 14.

Embodiments of the invention may be provided with drop guards 30 that are mounted adjacent to a left and right edge of the frame 12. The drop guards 30 help maintain the position of items on the conveyor transport surface 14, 16. For example, a drop guard 30 might stop an item from falling off the conveyor transport surface 14, 16. The drop guards 30 may have a variety of configurations such as a bar, a rail, a series of spaced-apart points of contact, or a vertical plane as shown in FIG. 1. Moreover, the drop guards 30 may be any suitable material such as metal, plastic, or wood, and can be attached by methods that are known in the art, such as by welding, gluing, or fastening.

The drop guards 30 may extend for the entire length of the frame 12, or only for part of the length. In FIG. 1 the drop guards 30 only extend for a first portion 18 of the frame 12, and are not on a second portion 20 of the frame 12. Having at least a portion 20 of the frame 12 without drop guards 30 allows workers to move items on and off the conveyor 10 without having to lift the items up over the drop guards 30. Without the drop guards 30, the workers can merely slide the items over the frame 12.

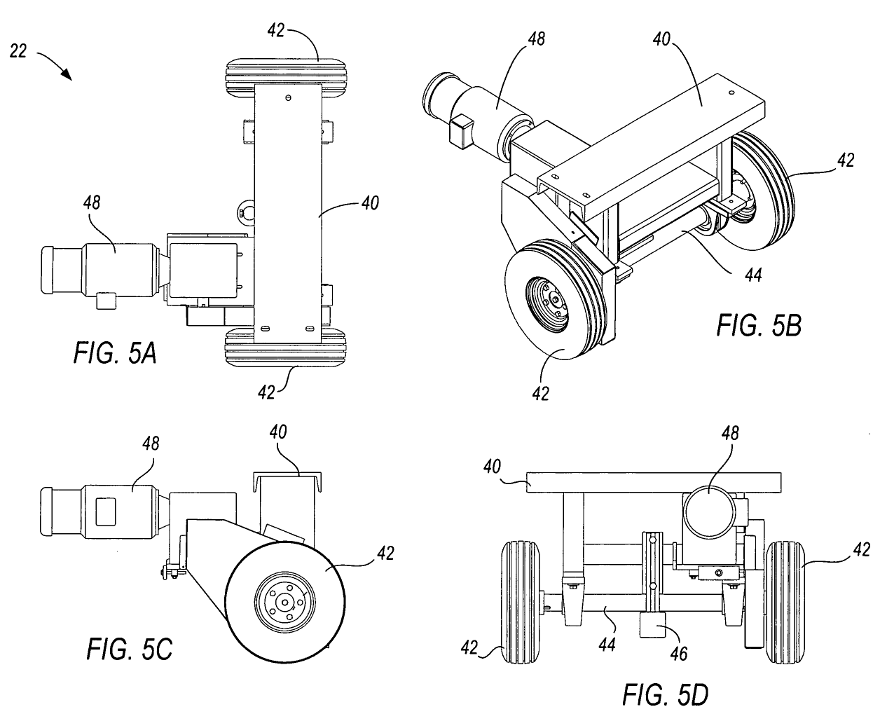

Conveyors 10 according to some embodiments of the invention have a discharge end wheel assembly 22 mounted to the bottom surface of the frame 12. In FIG. 5, the mount 40 is a horizontal plate with holes through the plate to accommodate fasteners, which are used to mount the discharge end wheel assembly 22 to the frame 12. In other embodiments, the mount 40 could be welded or glued to the bottom surface of the frame 12, or the mount 40 could have clamps or ties to affix the wheel assembly 22 to the frame 12. As shown in FIG. 5, the discharge end wheel assembly 22 may additionally have at least two wheels 42, an axle 44, a guide roller 46, and a motor 48. As will be discussed in more detail below, the motor 48 may be used to power the conveyor 10 to extend into a trailer 80. In other embodiments without a motor 48, the conveyor 10 can be extended into the trailer 80 by other means, such as by pushing or pulling the conveyor 10.

In some embodiments of the invention the discharge end wheel assembly 22 is mounted to the frame 12 at a distance of approximately L₂ from the discharge end of the frame 12. The variable L₂ may be related to the length L₁ of a trailer 80 or to the overall length L_{C} of the conveyor 10.

First, the distance L₂ may be related to the length L₁ of the trailer 80. Trailers 80 may have a variety of lengths L₁, including lengths of 28, 40, 45, and 53 feet. The length L₂ is shorter than the length L₁ to help ensure that the conveyor 10 does not collide with the back wall of the trailer 80. For example, if L₂ is too large, a worker might accidentally extend the conveyor 10 too far into the trailer 80, causing the discharge end of the conveyor 10 to collide with the trailer 80. Also, the length L₂ is shorter than L₁ to provide room for a worker to stand in front of the conveyor 10 when it is inside the trailer 80. For example, a worker will typically require a 5-7 foot space in front of the discharge end of the conveyor 10 in which to walk and load items. In some embodiments when the length L₁ of the trailer is 28 feet, the distance L₂ ranges from approximately 21-23 feet, or approximately 75-82% of L₁. In other embodiments when the length L₁ of the trailer is 40 feet, the distance L₂ ranges from approximately 33-35 feet. In still other embodiments when the length L₁ of the trailer is 45 feet, the distance L₂ ranges from approximately 38-40 feet. In these embodiments, the distance L₂ may range from approximately 83-88% of L₁.

Second, the distance L₂ may be related to the overall length L_{C} of the conveyor 10. In the embodiment shown in FIGS. 1-3, the overall length L_{C} of the conveyor is approximately 57 feet, and the distance L₂ associated with the discharge end wheel assembly 22 is approximately 24 feet, or approximately 42% of L_{C}. In other embodiments, however, the distance L₂ may range from approximately 40-45% of L_{C}. As the ratio L₂ to L_{C} changes, it may be necessary to apply counter weights to the receiving end of the conveyor 10, so that the weight of the frame 12 beyond the discharge end wheel assembly 22 does not cause the conveyor 10 to tip forward at the discharge end wheel assembly 22.

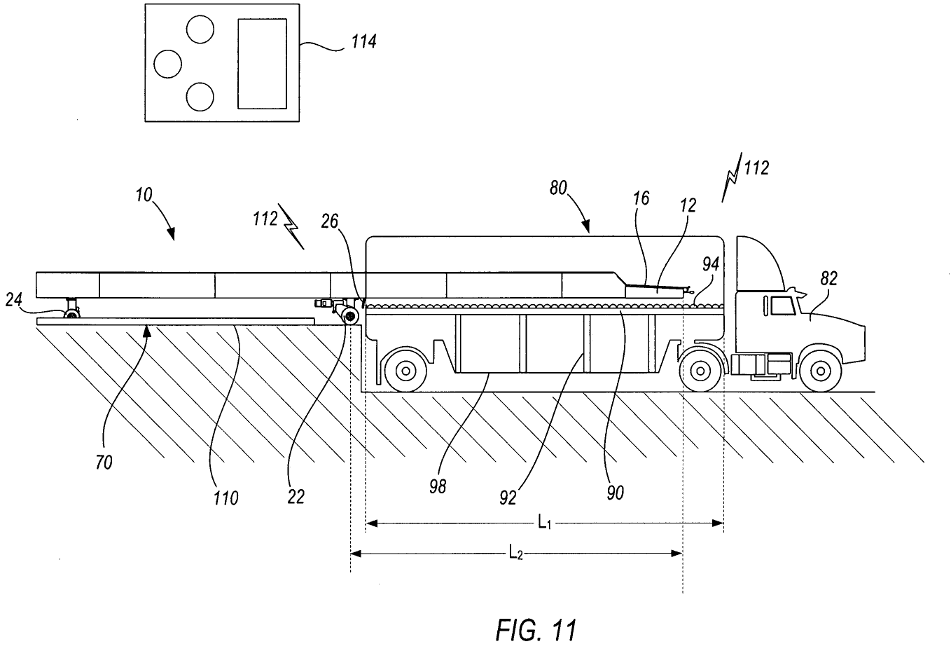

The position of the discharge end wheel assembly 22 of some embodiments provides ergonomic benefits to workers. As shown in FIG. 11, when the conveyor 10 is fully extended, the discharge end of the conveyor 10 is close to the back of the trailer 80 near the cab 82. Therefore, a worker can easily receive items from the conveyor 10 and place them in the back of the trailer 80 without having to walk long distances within the trailer 80. For example, if the conveyor 10 only extended partially into the trailer 80, then the worker would have to receive an item from the conveyor 10, walk the length L₁ of the trailer 80, and deposit the item in the back of the trailer 80. Walking long distances with items is not beneficial because it increases the time it takes for a worker to load the trailer 80, therefore decreasing efficiency. Additionally, walking long distances with items exposes the worker to the risk of injury by strain or stress.

Some trailers, for example drop-frame trailers 80, have trailer conveyor assemblies 90 mounted on the bottom interior surface 98 of the trailer 80. A trailer conveyor assembly 90 may be comprised of a frame 92 and a trailer transport surface 94. The trailer transport surface 94 eases the transportation of items within the trailer 80, and may be comprised of rollers, a belt, skate wheels, or a smooth plane. For example, a worker may place and slide an item over the trailer transport surface 94 instead of manually walking the item across the trailer 80 or pushing the item along the bottom interior surface 98 of the trailer. The frame 92 of the trailer conveyor assembly 90 may elevated a certain height from the bottom surface 98 of the trailer 80. For example, in some trailers 80 the frame 92 is elevated twenty four (24) inches above the bottom interior surface 98 of the trailer 80. The frame 92 is elevated to improve the ergonomics of using the trailer conveyor assembly 90. For example, if the frame 92 is elevated then a worker using the trailer conveyor assembly 90 will not have to bend over to the bottom interior surface 98 to transport items. Instead, an elevated frame 92 allows a worker to simply transport items using the trailer conveyor assembly 90 without needing to bend over.

Some trailer conveyor assemblies 90 are tall and extend above the height of the dock 110, as shown in FIG. 11. Using known conveyors in conjunction with trailers 80 having tall trailer conveyor assemblies 90 presents several risks. For example, the frame of a known conveyor might collide with the trailer conveyor assembly 90 when it is inserted into the trailer 80. Such collisions can damage the conveyor, the trailer conveyor assembly 90, or both. These collisions can impair efficiency and increase the cost of using a conveyor with a trailer.

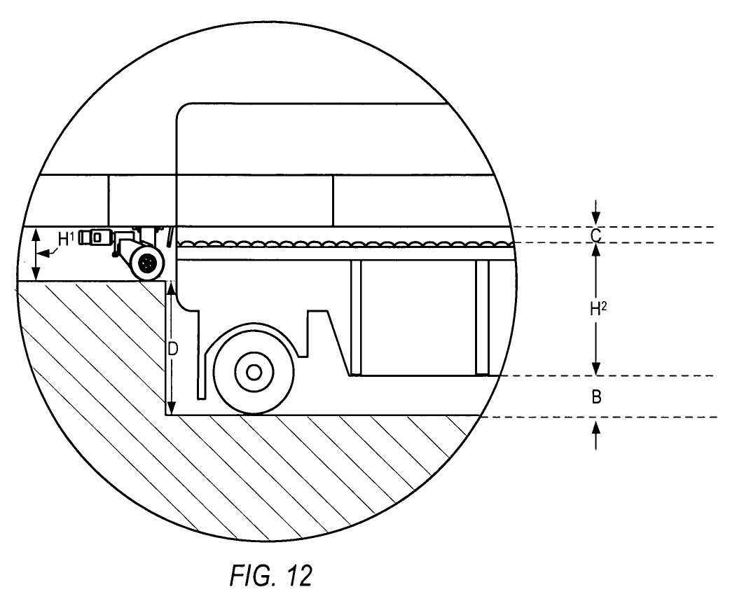

Conveyors 10 according to some embodiments of the invention are positioned at a certain height to avoid collision with a trailer conveyor assembly 90 when the conveyor 10 is extended into the trailer 80, however. In FIG. 12, the distance from the bottom surface of the frame 12 to the surface of the dock 110 is denoted with the symbol H₁. Also, the distance from the top surface of the trailer conveyor assembly 90 to the bottom interior surface 98 of the trailer 80 is denoted with the symbol H₂. The heights H₁ and H₂ are related based on the dimensions of particular embodiments of the dock 110, trailer 80, and conveyor 10. In FIG. 12, D represents the height of the dock and B represents the distance between the bottom surface 98 of the trailer and the ground. Typically D and B are set values, determined by the dimensions of the dock and the trailer, and are not subject to change. For example, the dock height D is typically 48″, but can vary by a few inches. The distance B may vary slightly depending on the size of the tires, and how inflated the tires are, or how heavy the trailer is.

The dimension C represents the desired clearance between the top surface of the trailer conveyor assembly 90 and the bottom surface of the frame 12. Having a clearance C helps to ensure that the conveyor 10 will not collide with the trailer conveyor assembly 90. The dimension C may be determined based upon a particular application for the conveyor 10. For example, in some instances it may be desired to have more or less clearance C between the frame 12 and the trailer conveyor assembly 90. FIG. 12 shows that the various heights may be related with the following equation: H₁+D=C+H₂+B.

In the embodiment shown in FIGS. 1-3, the overall length L₃ of the conveyor is 56 feet, 10 and ½ inches. The length L₂ associated with the discharge end wheel assembly is 24 feet, ¼ inches. The length Q associated with the obstruction sensor is 21 feet, 1 and ⅛ inches. The width of the frame is 44 and ⅝ inches, and the height H₁ is 28 inches. The embodiment in FIGS. 1-3 is not limiting and the current invention includes dimensions that are enabled by this specification other than those specifically shown in these figures.

Embodiments of the invention are provided with an obstruction sensor 26 that detects obstructions when the conveyor 10 is extended into the trailer 80, such obstructions including the trailer conveyor assembly 90. The obstruction sensor 26 may be mounted on the bottom surface of the frame 12 in front of the discharge end wheel assembly 22 at a distance of Q, for example. In the embodiment shown in FIG. 3, the distance Q is approximately 21 feet. As the conveyor 10 extends into the trailer 80, the bottom surface of the frame 12 extends substantially parallel to the trailer conveyor assembly 90. If the obstruction sensor 26 encounters an obstruction, such as the trailer transport surface 94 or an edge of the frame 92, the obstruction sensor 26 may generate a signal 112 to indicate that it has encountered the obstruction. In the embodiment shown in FIG. 11, for example, the obstruction sensor 26 is a hinged flap. As the conveyor 10 extends into the trailer 80, the hinged flap encounters the trailer conveyor assembly 90, and thereby the obstruction sensor 26 generates a signal 112 to indicate that it has encountered the trailer conveyor assembly 90.

The obstruction sensor 26 may be a mechanical sensor such as a button, a dashpot, or a spring. The obstruction sensor 26 may also be a camera, an actuator, an ultrasonic sensor, or a proximity sensor such as an inductive proximity sensor, a photoelectric sensor, or a capacitive proximity sensor. The signal 112 can include, for example, an audible signal such as a beep, horn, or buzzer. The signal 112 can also be visual, such as blinking lights or an extendable flag. The signal 112 can be an electronic, digital, or analog signal.

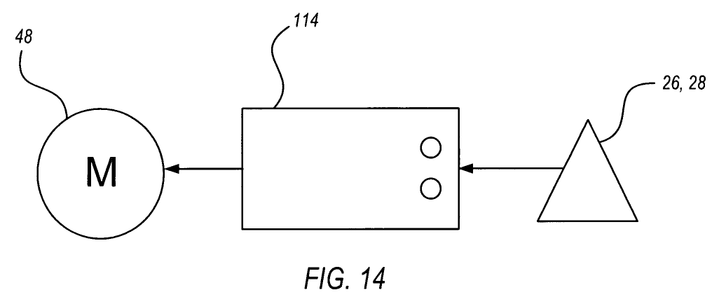

As illustrated in FIGS. 11 and 14, an operational system 114 may then receive the signal 112 from the obstruction sensor 26 and may initiate a command in response to the signal 112. The operational system 114 may be a human operator, a programmable logic controller (PLC), a computer, a hand-held device, or a graphical user interface. The operational system 114 may include functionality that issues commands to perform some action on the conveyor 10 pursuant to the signal 112, for example, in FIG. 14 the command is issued to the motor 48. In some embodiments the command is to stop the conveyor 10 from extending into the trailer 80 beyond the length L₂. The operational system 114 may carry out the command by applying a breaking force to the conveyor 10, or causing the motor 48 to power-off, thereby causing the conveyor 10 to stop. In other embodiments the command is to back up the conveyor 10 away from the trailer 80. The operational system 114 may carry out the command by causing the motor 48 to reverse polarity and to reverse away from the trailer 80. Operational systems such as are described in the product manual for the “BestReach Rigid Belt,” published by Best Diversified Products, Inc., of Jonesboro, Ark. are suitable for use in some embodiments of the invention.

In some embodiments, the obstruction sensor 26 is adjustably mounted on the bottom surface of the frame 12 at a location that may be determined by the geometries of the particular use. For example, if the obstruction sensor 26 is mounted on the frame 12 directly in front of the discharge end wheel assembly 24, then the conveyor 10 can be extended into the trailer 80 for approximately the length L₂ without the obstruction sensor 26 encountering the trailer conveyor assembly 90. On the other hand, if the obstruction sensor 26 is mounted on the frame 12 approximately near the discharge end of the frame 12, then the conveyor 10 will only be extended for a fraction of the length L₂ before the obstruction sensor 26 encounters the trailer conveyor assembly 90. It may be desirable to change the location of the obstruction sensor 26 depending upon the length L₁ of a particular trailer 80. For example if there is a trailer 80 with a relatively short length L₁, the obstruction sensor 26 may be mounted at certain percentage of the length L₁ in front of the discharge end wheel assembly 90. Alternatively, if the trailer 80 has a relatively long length L₁, then the obstruction sensor 26 may be mounted at a different percentage of the length L₁.

Some embodiments of the invention may additionally have a bumper bar 28. Like the obstruction sensor 26, the bumper bar 28 may generate a signal 112 when the bumper bar 28 encounters an obstruction. For example, the bumper bar 28 may encounter the back wall of the trailer 80 if the conveyor 10 is extended too far into the trailer 80. Alternatively, the bumper bar 28 may encounter the side wall of the trailer 80 if the conveyor 10 is being steered into the trailer 80 at a crooked angle. If there is a worker inside the trailer, the bumper bar 28 could generate a signal 112 if the worker depresses the bumper bar 28. The worker could purposefully depress the bumper bar 28 if the worker desired to stop the extension of the conveyor 10 into the trailer 80.

Like the obstruction sensor, the bumper bar 28 may be a mechanical sensor such as a button, a dashpot, or a spring. It can also be a camera, an actuator, an ultrasonic sensor, or a proximity sensor such as an inductive proximity sensor, a photoelectric sensor, or a capacitive proximity sensor. The signal 112 can include, for example, an audible signal such as a beep, horn, or buzzer. The signal 112 can also be visual, such as blinking lights or an extendable flag. The signal 112 can be an electronic, digital, or analog signal. As shown in FIG. 14, an operational system 114 may then receive the signal 112 from the bumper bar 28 and may initiate a command that causes the conveyor 10 to take some action. In the embodiment in FIG. 14, the operational system 114 issues a command to the motor 48. For example, in some embodiments, the command is to stop extending the conveyor 10 into the trailer 80.

In other embodiments, receipt of the signal 112 from the bumper bar 28 may cause the operational system 114 to initiate a command to back the conveyor 10 away from the trailer 80 and towards the dock 110. Such a command is beneficial if a worker is inside the trailer 80 loading items. For example, if the worker is loading items and needs more room to load additional items, the worker can purposefully depress the bumper bar 28, which will cause the conveyor 10 to back up, thus providing the worker with more space in which to load items. In some embodiments, the conveyor 10 will only back up a specified distance, for example, only a three foot distance. Limiting the distance that the conveyor 10 will back up improves safety. For example, if there were no limit to the back-up distance, then the conveyor 10 would be out of the worker's reach, and the worker be unable to stop the conveyor 10 from backing up. Also, if the conveyor continued to back up, it could collide with an object or person standing behind the conveyor 10.

As described, the operational system 114 may receive signals 112 from the obstruction sensor 26 and/or the bumper bar 28. In other embodiments, the operational system 114 is further provided with a control panel that may include buttons, switches, pulls, knobs, or a joystick (not shown) on the frame 12. A worker may use the control panel to initiate a signal 112 to cause the operational system 114 to initiate a command. For example, the control panel may have a stop, power-off, reset, drive, or reverse button. In some embodiments, the control panel is located at the discharge end of the frame 12 so that a worker inside the trailer 80 has access to the control panel. In other embodiments the control panel is located on the receiving end of the frame 12, or there may be at least two control panels located at different locations on the frame 12.

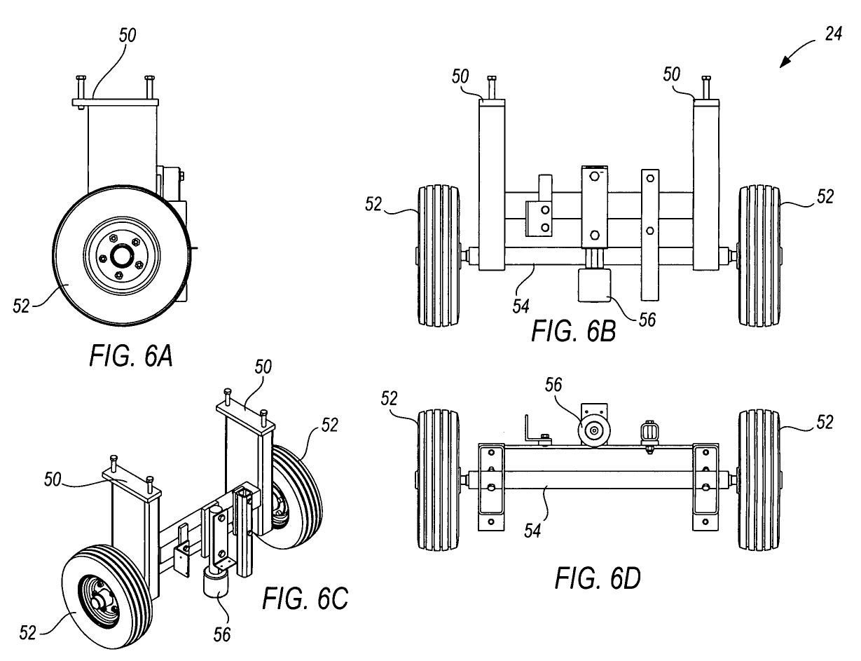

Embodiments of the invention also have a receiving end wheel assembly 24. The receiving end wheel assembly 24 may be mounted anywhere between the receiving end of the frame 12 and the discharge end wheel assembly 22; typically however, the receiving end wheel assembly 24 is located closer to the receiving end of the frame 12 than to the discharge end wheel assembly 22. The receiving end wheel assembly 24 may be mounted to the bottom surface of the frame 12. In FIG. 6, the mount 50 of the assembly 24 is a pair of horizontal plates with bolts extending therefrom. In other embodiments, the mount 50 could be welded or glued to the bottom surface of the frame 12, or the mount 50 could have clamps or ties to affix the wheel assembly 24 to the frame 12. As shown in FIG. 6, the receiving end wheel assembly 24 may additionally have at least two wheels 52, an axle 54, and a guide roller 56. Although not shown in FIG. 6, the receiving end wheel assembly 24 can have a motor to drive the conveyor 10 into a trailer 80.

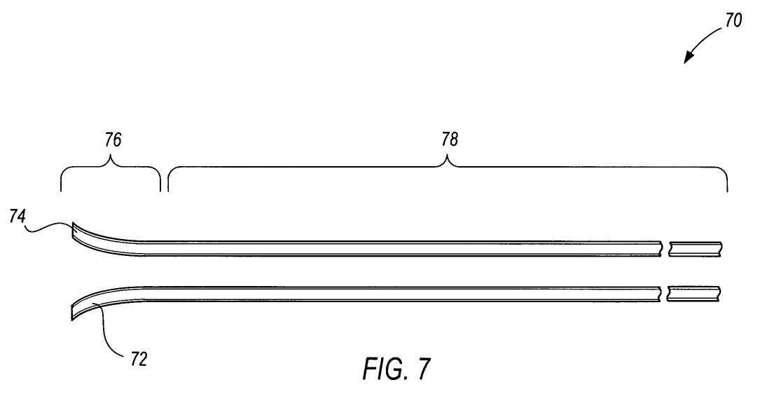

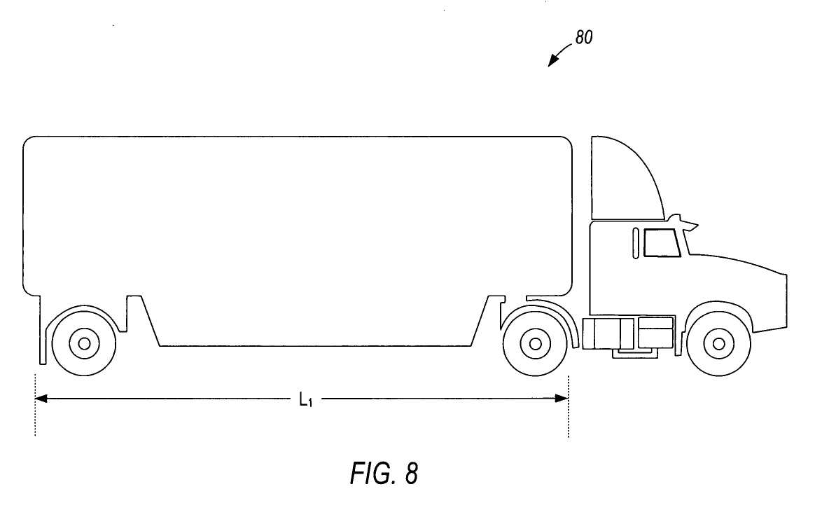

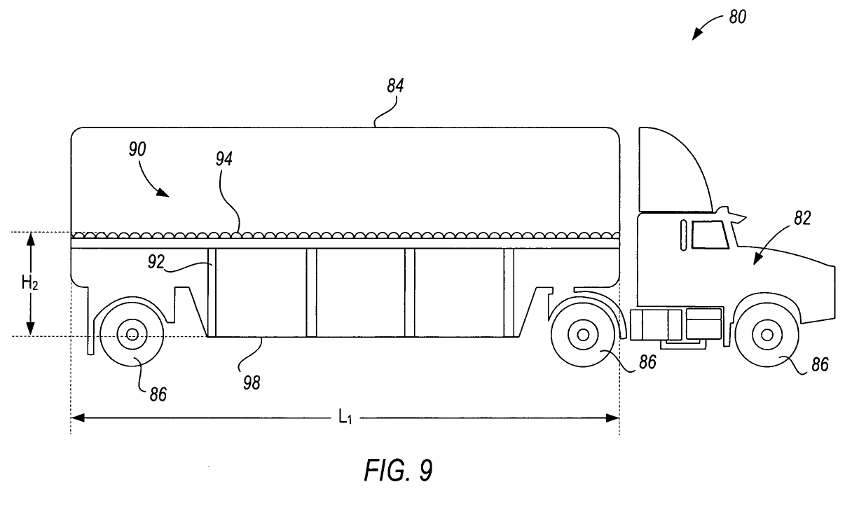

In some embodiments of the invention, the guide rollers 46, 56 of the respective wheel assemblies 22, 24 cooperate with a guide rail assembly 70. As shown in FIG. 7, embodiments of the guide rail assembly 70 include a first guide rail 72 and a second guide rail 74. Each guide rail 72, 74, may have a curved portion 76 and a straight portion 78. In operation, the guide rollers 46, 56 fit in the channel that is formed between the first and second guide rails 72, 74. In some embodiments, when the conveyer 10 is fully contracted on the dock 110, the guide rollers 46, 56 are positioned between the straight portion 78 of the guide rails 72, 74. As the conveyor 10 extends into the trailer 80, the wheel assemblies 22, 24 extend, and the guide rollers 46, 56 translate in the straight portion 78 of the channel. The straight portion 78 of the channel helps to ensure that the conveyor 10 is extended straight into the trailer 80, without becoming crooked and colliding with a wall of the trailer 80. When the workers finish using the conveyor 10, they can contract it back into the dock 110. As the conveyor 10 moves back towards the dock 110, the guide rollers 46, 56 translate in the guide rail assembly 70. The curved portion 76 helps ensure that the guide rollers 46, 56 are realigned in the guide rail assembly 70 when the conveyor 10 is contracted from the trailer 80 back towards the dock 110.

Each guide rail 72, 74 may be constructed from a variety of materials, including metal, wood, or plastics, and may be affixed to the surface of the dock 110 by known methods such as welding, glue, or by the use of fasteners such as nuts, bolts, and screws.

The guide rail 70 assembly is beneficial because it reduces the degrees of freedom of the conveyor 10 when the conveyor 10 is in use. For example, conveyors that are able to be steered have several degrees of freedom—they can move in any number of angles to the left or right. Increasing the degrees of freedom also increases the possibility of colliding the conveyor with the trailer, with any trailer conveyor assemblies located therein, with workers, or with items housed within the trailer. As discussed above, collisions with the trailer conveyor assembly may be particularly detrimental. Embodiments of the invention with the guide rail assembly 40 reduce the degrees of freedom—and also reduce the likelihood of collision—by allowing the conveyor 10 to only move in a straight line.

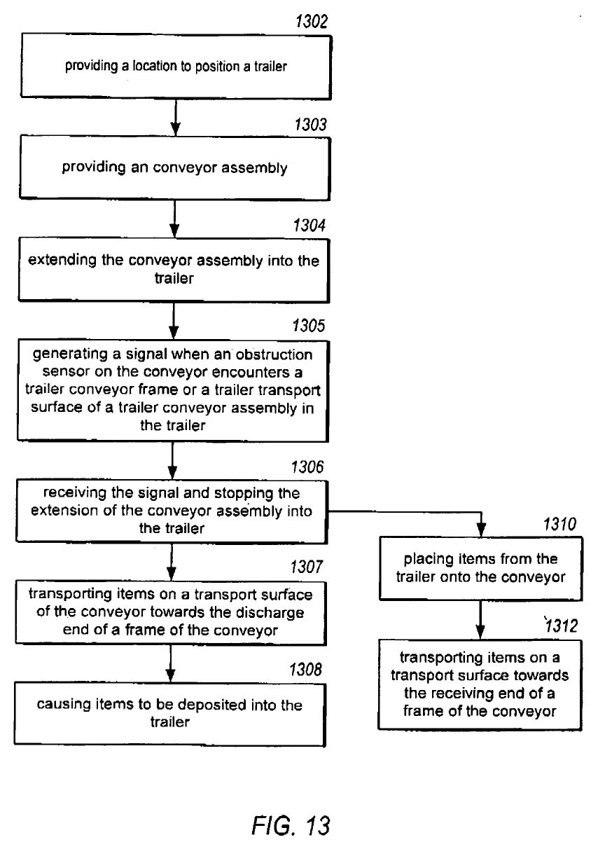

Embodiments of the invention can be used to perform methods for loading items into a trailer, or for unloading items from a trailer. One embodiment of a method is illustrated in FIG. 13. In step 1302, for example, the method involves providing a location to position a trailer. The trailer may be a drop-frame trailer 80 as described above with a trailer conveyor assembly 90. Alternatively, the trailer may be a flat-bed trailer, a truck, or a dock-height trailer. The location in step 1302 may be a dock 110 that is associated with a warehouse, a distribution center, or a storage facility. As discussed above, the dock 110 might be associated with a warehouse that has an internal built-in conveyor system and offshoot conveyors.

The next step 1303 involves providing a conveyor assembly, for example, the embodiment of the conveyor 10 illustrated in FIG. 1. Embodiments of conveyors 10 may have a frame 12, a transport surface 14, 16, a discharge-end wheel assembly 22, and an obstruction sensor 26 as described above. The conveyor assembly 10 can be provided on the surface of the dock 110, or it can be housed within the warehouse, distribution center, or storage facility that is associated with the dock 110. If the dock 110 has an internal conveyor system and offshoot conveyors, then the conveyor 10 may be positioned or parked beneath the offshoot conveyor of the dock 110.

In some embodiments, the next step 1304 is to extend the conveyor assembly 10 into the trailer 80. For example, embodiments of conveyors 10 having a motor 48 on the discharge end wheel assembly 22, or the receiving end wheel assembly 24, can be driven along the surface of the dock 110 towards the trailer 80. If the conveyor 10 does not have a motor 48, then the conveyor 10 may be pushed or pulled along the surface of the dock 110 towards the trailer 80. When the conveyor 10 is extended into the trailer 80, the bottom surface of the frame 12 is substantially parallel to the trailer transport surface 94, and may be offset from the trailer transport surface 94 by a clearance distance C. The clearance distance C reduces the possibility that the frame 12 of the conveyor 10 collides with the trailer transport assembly 90.

Embodiments may include the step 1305 of generating a signal 112 when an obstruction sensor 26 on the conveyor 10 encounters the trailer conveyor frame 92 or the trailer transport surface 94 of the trailer conveyor assembly 90. As described above, as the conveyor 10 extends into the trailer 80, the bottom surface of the frame 12 extends substantially parallel to the trailer conveyor assembly 90. If the obstruction sensor 26 encounters the trailer conveyor assembly 90, then the obstruction sensor 26 may generate a signal 112 to indicate that it has encountered an obstruction. The signal 112 can take on a variety of embodiments, such as audible, visual, electronic, digital, or analog signals.

Some methods may further include the step 1306 of receiving the signal 112 and stopping the extension of the conveyor assembly 10 into the trailer 80. As described above, in some embodiments an operational system 114 receives the signal 112. The operational system 114 may be a PLC, a human operator, a computer, a hand-held device, or a graphical user interface. Additionally, in some embodiments the operational system 114 may stop the extension of the conveyor 10 into the trailer 80 by issuing a command, which may be an audible, visual, or electronic command. For example, the command could be an electronic impulse that causes the operational system 14 to apply breaking force to the conveyor 10, or that causes the motor 48 on the discharge end wheel assembly 22 to power-off, thereby causing the conveyor 10 to stop.

In step 1307 of some embodiments, items are transported on the transport surface 14, 16 of the conveyor 10 towards the discharge end of the frame 12 of the conveyor 10. As discussed above, the transport surface 14, 16 may include rollers, a belt, skate wheels, or a smooth plane. If the transport surface 14, 16 is a belt, the belt could be driven by a motor, thereby causing items to be driven down the transport surface 14, 16. Alternatively, items may simply be pushed or pulled down the transport surface 14, 16. In some embodiments, a first worker will stand on the dock 110 near the receiving end wheel assembly 24 and place items on the transport surface 14, 16. In other embodiments that have offshoot conveyors on the dock 110, items are placed on the transport surface 14, 16 when they drop or slide off of the offshoot conveyor.

In 1308, there may be a step of causing items to be deposited into the trailer 80. For example, a second worker who is standing on the bottom interior surface 98 of the trailer 80 may receive items that are located on the discharge end of the frame 12 of the conveyor 10, and may deposit the items within the trailer 80. Alternatively, if there is no worker present in the trailer 80, then items that are transported on the transport surface 14, 16 of the conveyor 10 may simply slide off the transport surface 14, 16 and be deposited within the trailer 80.

The methods outlined above may be repeated in reverse order to unload items from a trailer 80 using the conveyor 10. When the conveyor 10 is used to unload items, the method generally involves steps 1302-1306. For example, a method for unloading a trailer may include 1302 providing a location to position a trailer that is at least partially loaded with items, and 1303 providing a conveyor assembly. Further, a method for unloading items may include 1304 extending the conveyor 10 into the trailer 80. If the trailer 80 is loaded full with items, then the conveyor 10 may be extended only partially into the trailer 80. As items are removed, the conveyor 10 may be extended further into the trailer 80. As the conveyor 10 extends, the method may include 1305 generating a signal 112 when the sensor 26 encounters the trailer conveyor assembly 90 or other objects such as items inside the trailer 80, and the step 1306 as described above.

In some methods for unloading a trailer 80, there may be a step 1310 of placing items from the trailer 80 onto the second transport surface 16. In these embodiments, the second transport surface 16 may be generally parallel to the first transport surface 14, and not slanted as shown in the figures, in order to avoid having to push items up a slanted second transport surface 16. The step 1310 may be performed before, or interspersed with, the steps 1304-1306. For example, if the trailer 80 is very full so that the conveyor 10 cannot be extended into the trailer 80, then step 1310 may be performed before step 1304.

In step 1312 of some embodiments, items are transported on the transport surface 14, 16 of the conveyor 10 towards the receiving end of the frame and the dock. When items reach the receiving end of the frame 12, a worker may remove the items from the conveyor 10, or the items may be diverted onto an offshoot conveyor associated with the dock 110.

The foregoing is provided for purposes of illustration and disclosure of a preferred embodiment of the invention. Changes, deletions, additions, and modifications may be made to the structures disclosed above without departing from the scope or spirit of the present invention. For example, the systems and methods described herein may be modified to allow for unloading of items from a trailer.

1. A method of loading items into a trailer, the method comprising:
a. providing a location to position a trailer with a length L₁, the trailer comprising: a trailer conveyor assembly connected to a bottom interior surface of the trailer, the trailer conveyor assembly comprising a trailer conveyor frame and a trailer transport surface;
b. providing a conveyor assembly, the conveyor assembly comprising:
i. a frame with a top surface, a bottom surface, and a discharge end;
ii. a transport surface rotatably connected to the top surface of the frame;
iii. a discharge-end wheel assembly coupled to the bottom surface of the frame at a distance of approximately L₂ from the discharge end of the frame, where the distance L₂ is approximately 75-88% of L₁;
iv. an obstruction sensor connected to the bottom surface of the frame between the discharge-end wheel assembly and the discharge end of the frame to preclude the conveyor from extending into the conveyor past the length L₂;
c. extending the conveyor assembly into the trailer, wherein when the conveyor assembly is extended into the trailer, the bottom surface of the frame is substantially parallel to the trailer transport surface;
d. generating a signal when the obstruction sensor encounters the trailer conveyor frame or the trailer transport surface of the trailer conveyor assembly;
e. receiving the signal and stopping the extension of the conveyor assembly into the trailer beyond the length L₂;
f. transporting items on the transport surface towards the discharge end of the frame; and
g. causing items to be deposited into the trailer.

2. A method as in claim 1, further comprising causing items to be received on the trailer transport surface and transporting items on the trailer transport surface into the trailer.

3. A method as in claim 1, wherein the conveyor assembly has a distance L₂ that is approximately 75-82% of L₁.

4. A method as in claim 1, wherein the conveyor assembly further comprises a bumper bar on the discharge end of the frame.

5. A method as in claim 4, further comprising:
g. generating a bumper signal when the bumper bar encounters an object; and
h. receiving the bumper signal and completing a reaction, wherein the reaction comprises at least one of stopping the extension of the conveyor assembly into the trailer, or causing the conveyor to back up away from the trailer.

6. A method as in claim 1, wherein the trailer transport surface or the transport surface comprises at least one of rollers, a belt, skate wheels, or a smooth plane.

7. A method as in claim 1, further comprising providing an operational system to receive the signal and to thereafter initiate a command to stop the extension of the conveyor assembly into the trailer.

8. A system for transporting items to and from a loading dock with a height D, the system comprising:
a. a conveyor having an overall length L_{C} and comprising:
i. a frame with a top surface, a bottom surface, and a discharge end;
ii. a conveyor transport surface rotatably mounted to the top surface of the frame; and
iii. a discharge-end wheel assembly coupled to the bottom surface of the frame, and set back from the discharge end of the frame at a distance of approximately 40-45% of L_{C};
b. a trailer, comprising a bottom interior surface with a first portion and a second portion, the second portion comprising a trailer transport surface that is elevated from the first portion by a height H₂;
c. wherein when the conveyor is inserted into the trailer,
i. the bottom surface of the frame is substantially parallel to the trailer transport surface and is offset from the trailer transport surface by a clearance C; and
ii. there is adequate space between the discharge end of the frame and a far wall of the trailer for a worker to stand and load items.

9. A system as in claim 8, wherein the conveyor transport surface or the trailer transport surface comprises at least one of rollers, a belt, skate wheels, or a smooth plane.

10. A system as in claim 8, wherein the conveyor further comprises a bumper bar mounted on the discharge end of the frame, wherein when the bumper bar encounters an object, the bumper bar generates a signal to cause at least one of stopping the insertion of the conveyor or backing the conveyor away from the trailer.

11. A system as in claim 8, wherein the bottom surface of the frame is located at a height H₁ above the dock, wherein the height H₁ approximately equals:
a) the sum of the height H₂, a distance B from the ground to the bottom surface of the trailer, and the clearance C;
b) minus the height of the dock D.

12. A system as in claim 8, the discharge end wheel assembly comprising a guide roller.

13. A system as in claim 12, further comprising a guide rail assembly, the guide rail assembly comprising:
a. a channel defined by a straight portion of two rails; and
b. a funnel defined by a curved portion of the two rails, wherein the guide-roller of the discharge-end assembly translates in the channel and the funnel of the guide rail assembly.

14. A system as in claim 8, wherein the conveyor further comprises an obstruction sensor mounted on the bottom surface of the frame in front of the discharge-end wheel assembly, wherein the obstruction sensor generates a signal to stop insertion of the conveyor when the obstruction sensor encounters an edge of the trailer transport surface.

15. A system for transporting items to and from a loading dock, the system comprising:
a. a drop-frame trailer with a length L and a bottom interior surface, the trailer comprising a trailer transport surface mounted to at least a portion of the bottom interior surface of the trailer;
b. a conveyor comprising:
i. a frame with a top side, a bottom side, a receiving end, and a discharge end;
ii. a conveyor transport surface rotatably coupled to the top side of the frame;
iii. a wheel assembly comprising a first guide roller coupled to the bottom side of the frame at a distance of approximately five to seven feet less than L from the discharge end of the frame; and
iv. an obstruction sensor mounted on the bottom side of the frame at a location between the wheel assembly and the discharge end of the frame; and
c. wherein when the conveyor enters the drop-frame trailer, the bottom side of the frame translates substantially parallel to the trailer transport surface.

16. A system as in claim 15, wherein the obstruction sensor generates a signal to stop the conveyor when the obstruction sensor encounters an edge of the trailer transport surface.

17. A system as in claim 15, further comprising a support structure mounted to the bottom side of the frame between the wheel assembly and the receiving end of the frame, the support structure comprising a second guide roller.

18. A system as in claim 17, further comprising: a guide rail assembly, the guide rail assembly comprising:
a. a first guide rail with a straight portion and a flared portion; and
b. a second guide rail with a straight portion and a flared portion, wherein the first and second guide rails are mounted on the ground;
c. wherein when the conveyor extends into the drop frame trailer, the first and second guide rollers translate between the first and second guide rail.

19. A system as in claim 15, wherein the conveyor transport surface or the trailer transport surface comprises at least one of rollers, a belt, skate wheels, or a smooth plane.

20. A method of unloading items from a trailer, the method comprising:
a. providing a location to position a trailer with a length L₁, the trailer comprising: a trailer conveyor assembly connected to a bottom interior surface of the trailer, the trailer conveyor assembly comprising a trailer conveyor frame and a trailer transport surface;
b. providing a conveyor assembly, the conveyor assembly comprising:
i. a frame with a top surface, a bottom surface, and a discharge end;
ii. a transport surface rotatably connected to the top surface of the frame;
iii. a discharge-end wheel assembly coupled to the bottom surface of the frame at a distance of approximately L₂ from the discharge end of the frame, where the distance L₂ is approximately 75-82% of L₁;
iv. an obstruction sensor connected to the bottom surface of the frame between the discharge-end wheel assembly and the discharge end of the frame to preclude the conveyor from extending into the conveyor past the length L₂;
c. extending the conveyor assembly at least partially into the trailer, wherein when the conveyor assembly is extended into the trailer, the bottom surface of the frame is substantially parallel to the trailer transport surface;
d. generating a signal when the obstruction sensor encounters the trailer conveyor frame or the trailer transport surface of the trailer conveyor assembly;
e. receiving the signal and stopping the extension of the conveyor assembly into the trailer beyond the length L₂;
f. transporting items on the transport surface towards the receiving end of the frame; and
g. removing items from the conveyor assembly.
